(19) United States
(12) Patent Application Publication
(10) Pub. No.: US 2011/0317777 A1
(43) Pub. Date: Dec. 29, 2011

(54) Controlling Transmissions on Composite Carriers

(76) Inventors: Min Huang, Beijing (CN); Lei Du, Bejing (CN); Yong Teng, Bejing (CN)

(21) Appl. No.: 13/202,162

(22) PCT Filed: Feb. 18, 2009
(86) PCT No.: PCT/EP09/51911

§ 371 Date: Sep. 13, 2011

(51) Int. Cl. H04L 27/00

(52) U.S. Cl. 375/259

(57) ABSTRACT

Transmissions on a composite carrier including at least two component carriers can be controlled by means of a message by the provider of the carrier. The provider may receive a message from a device attempting to transmit on the composite carrier, and include in a response thereof an indication of at least one component carrier to be used by the device for a subsequent transmission. The device then received the message from the provider, and can determine based thereon at least one component carrier to be used by the device for at least one subsequent transmission, and transmit on the determined at least one component carrier.

The invention relates to relay a communication system, and more particularly to controlling transmissions on composite carriers.

A communication system can be seen as a facility that enables communication sessions between two or more entities such as mobile communication devices and/or other stations. The communications may comprise, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast content. Non-limiting examples of the content include downloads, television and radio programs, videos, advertisements, various alerts and other information.

A communication system can be provided for example by means of a communication network and one or more compatible communication devices. The communication system and associated devices typically operate in accordance with a given standard or specification which sets out what the various entities associated with the system are permitted to do and how that should be achieved. For example, the standard or specification may define if a communication device is provided with a circuit switched carrier service or a packet switched carrier service or both, and how the carriers are configured. Communication protocols and/or parameters which shall be used for the connection are also typically defined. For example, the manner how the communication device can access resources provided by the communication system and how communication shall be implemented between communicating devices, the elements of the communication network and/or other communication devices is typically based on predefined communication protocols.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

A carrier may comprise a composite carrier, i.e. a carrier that is provided by a plurality of sub or component carriers. Composite carriers may be provided by utilising what is known as carrier aggregation. In carrier aggregation a plurality of carriers are aggregated to increase bandwidth. Such carriers are known as aggregated carriers, each aggregated carrier comprising a plurality of component carriers.

The popularity of communication devices or user equipment (UE) has increased considerably in the recent years and the number of user devices in active use is believed to increase even further in the future. Thus the number of users who may want to access a communication system at substantially the same time is also believed to increase. The available bandwidth provided by the communications systems has also been increased, to provide more capacity to meet the increased demand. This has resulted in a situation where it is possible that a large number of user devices perform random access in a system, and more particularly, a carrier provided by the system.

An example of a modern communication system that is attempting to solve the problems associated with the increased demands for capacity is an architecture that is known as the long-term evolution (LTE) of the Universal Mobile Telecommunications System (UMTS) radio-access technology and that is being standardized by the 3^{rd} Generation Partnership Project (3GPP). The various development stages of the 3GPP LTE specifications are referred to as releases. The aim of the standardization is to achieve a communication system with, inter alia, reduced latency, higher user data rates, improved system capacity and coverage, and reduced cost for the operator. A further development of the LTE is referred to as LTE-Advanced. The LTE-Advanced aims to provide further enhanced services by means of even higher data rates and lower latency with reduced cost. A feature of the LTE-Advanced is that it is capable of providing aggregated carriers.

In systems where composite or aggregated carriers are available a problem is that the communication devices accessing the system are limited into the original component carrier they are assigned to. For example, the design of random access procedure in the medium access control (MAC) layer in LTE-A may become problematic. An approach inherited directly from the earlier versions of the 3GPP, in particular from Release 8 of the LTE, is to execute the whole random access process from preamble transmission to contention resolution within a single component carrier. However, as the number of communication devices that want to access the system is increased at the same time as the bandwidth provided in LTE-A is also increased, there is possibility that a large number of communication devices perform random access in one carrier. Because of this, and the nature of the carrier assignment by the random access procedure, preamble collisions can become more likely. Also, use of the same carrier for the subsequent communications may result in longer access delays and heavier load in the uplink channel resources.

It is noted that the above discussed issues are not limited to any particular communication environment, but may occur in any appropriate communication system where composite carriers may be provided.

Embodiments of the invention aim to address one or several of the above issues.

In accordance with an embodiment there is provided a method for controlling transmissions on a composite carrier comprising at least two component carriers, comprising receiving a message from a device attempting to transmit on the composite carrier, including in a response an indication of at least one component carrier to be used by the device for a subsequent transmission, and sending the response to the device.

In accordance with another embodiment there is provided a method for transmitting by a device on a composite carrier comprising at least two component carriers, comprising receiving a message from a provider of the composite carrier, determining based on the message at least one component carrier to be used by the device for at least one subsequent transmission, and transmitting on the determined at least one component carrier.

In accordance with another embodiment there is provided a control apparatus for a communication system capable of providing a composite carrier comprising at least two component carriers. The control apparatus is configured to control transmissions on the composite carrier based on information regarding an attempt by at least one device to transmit on the composite carrier, to include in a message to the at least one device an indication of at least one component carrier to be used by the at least one device for at least one subsequent transmission, and to send the message to the at least one device.

In accordance with another embodiment there is provided a control apparatus for a communication device adapted for communications on a composite carrier comprising at least two component carriers. The control apparatus is configured to control transmissions based on a message received from a provider of the composite carrier, wherein the control apparatus is configured to determine based on the message at least one component carrier to be used by the communication device for at least one subsequent transmission and to instruct transmission on the determined at least one component carrier.

In accordance with a more detailed embodiment, the indication is included in a random access response. The index of at least one component carrier may be included in a response message. An indication of a component carrier for a subsequent preamble retransmission or a scheduled transmission may be included.

Loading on component carriers may be distributed by sending different indications in response to different received messages and/or messages from different devices.

An indication associated with a component carrier may be included in a message periodically in the time domain or dynamically in response to load or another predefined event.

The composite carrier and the component carriers provide may carrier aggregation in accordance with the specifications by the third generation partnership project.

In accordance with an embodiment a response is received from the provider of the composite carrier within a predefined period. At least one component carrier to be used for the at least one subsequent transmission can be determined based on the response. The determining may comprise determining if the received message includes an indication of at least one component carrier to be used by the device for at least one subsequent transmission on the composite carrier. The determining may comprise determining if the received message contains a backoff indicator. The determining may comprise determining if the received message contains information regarding at least one component carrier to be used by the device for at least one subsequent transmission on the composite carrier. In the absence of such information, a default component carrier may be determined or a component carrier may be selected in random.

In accordance with an embodiment a message for controlling communications on a composite carrier comprising at least two component carriers is provided. The message comprises a medium access control protocol data unit configured to carry in at least one subheader thereof an indicator of a component carrier to be used by a communication device for at least one subsequent transmission.

A computer program comprising program code means adapted to perform the method may also be provided.

Various other aspects and further embodiments are also described in the following detailed description and in the attached claims.

The invention will now be described in further detail, by way of example only, with reference to the following examples and accompanying drawings, in which:

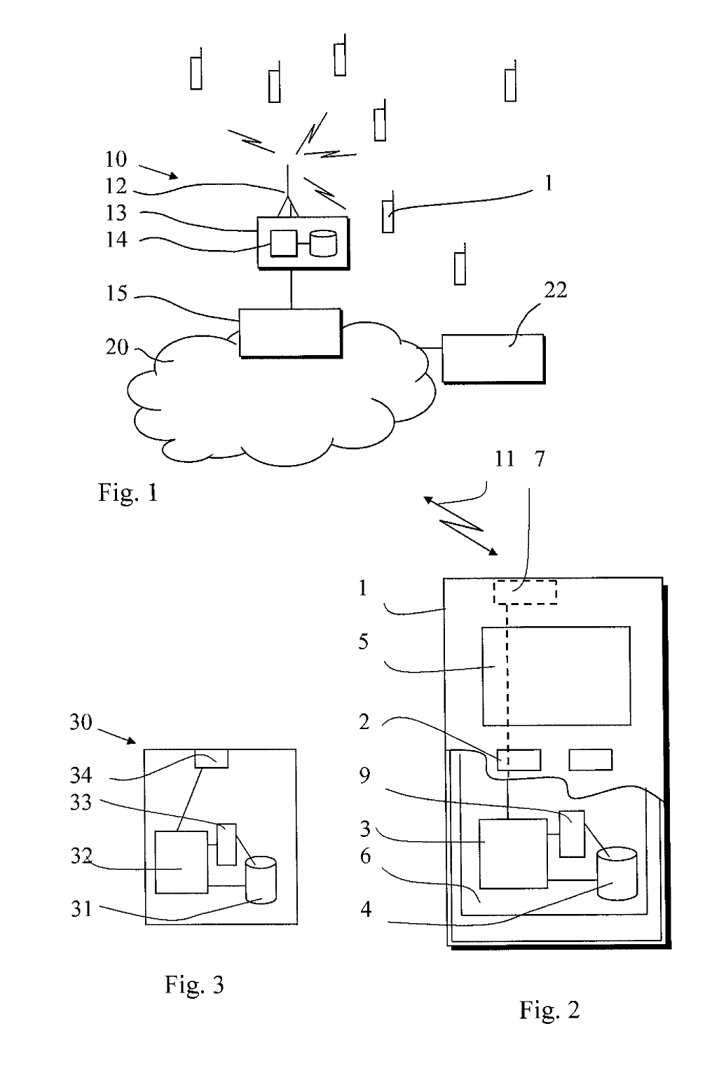

FIG. 1 shows an example of a communication system in which the embodiments of the invention may be implemented;

FIG. 2 shows an example of a communication device;

FIG. 3 shows an example of a controller for a base station;

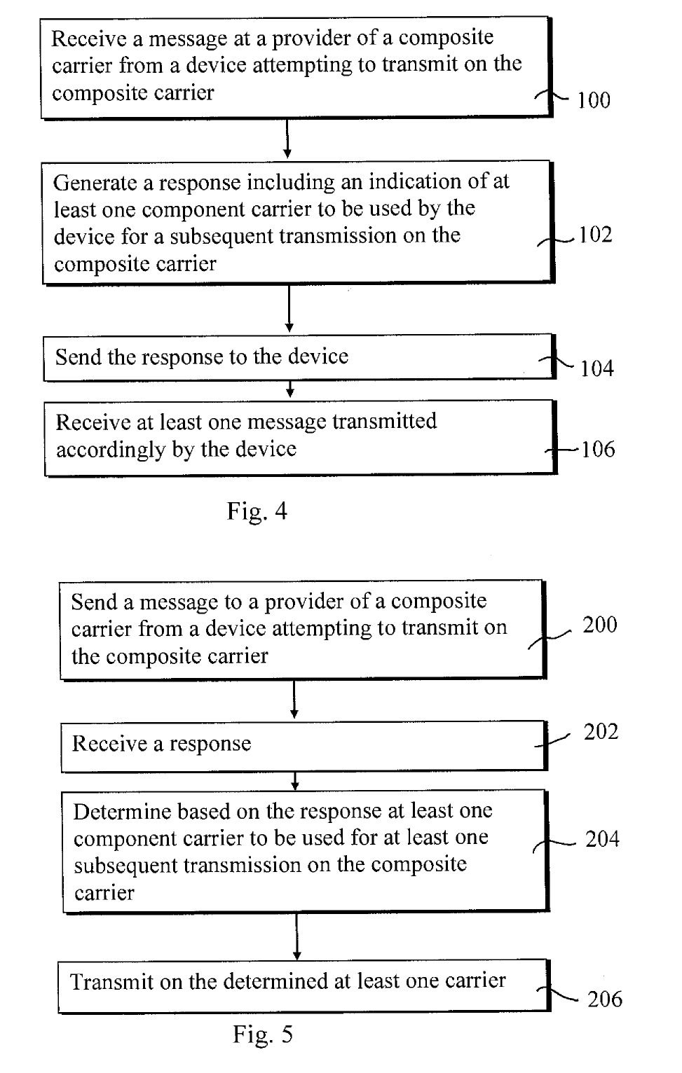

FIGS. 4 and 5 are flowcharts illustrating certain embodiments;

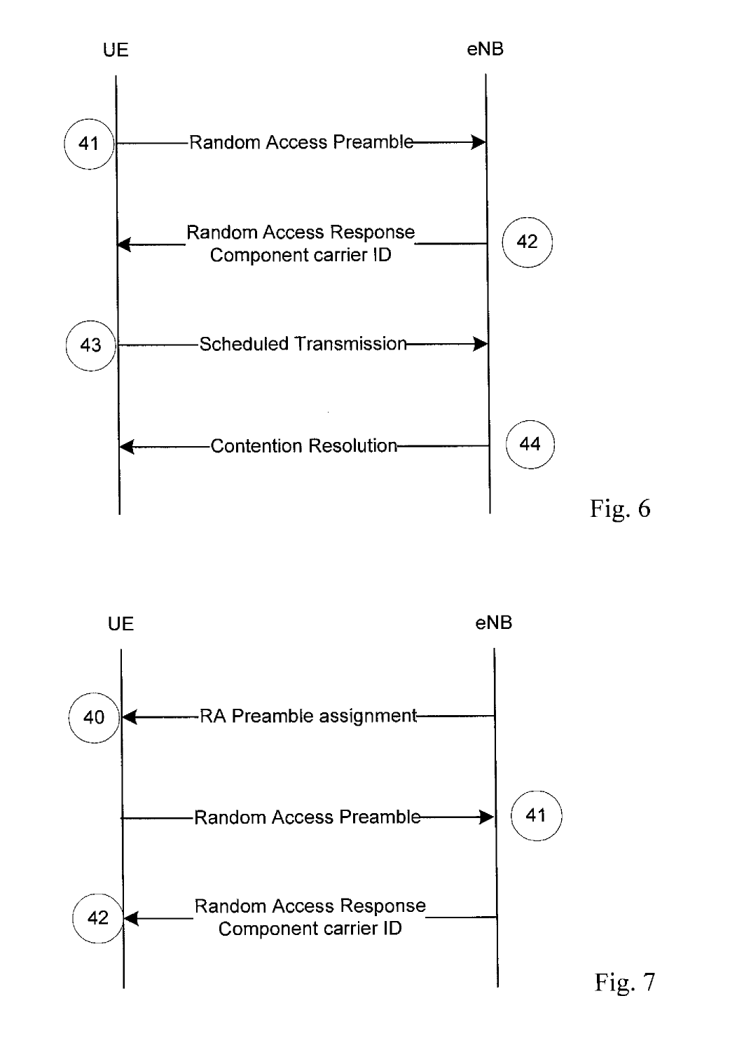

FIG. 6 shows a signalling flow for a contention based random access procedure;

FIG. 7 shows a signalling flow for a non-contention based random access procedure;

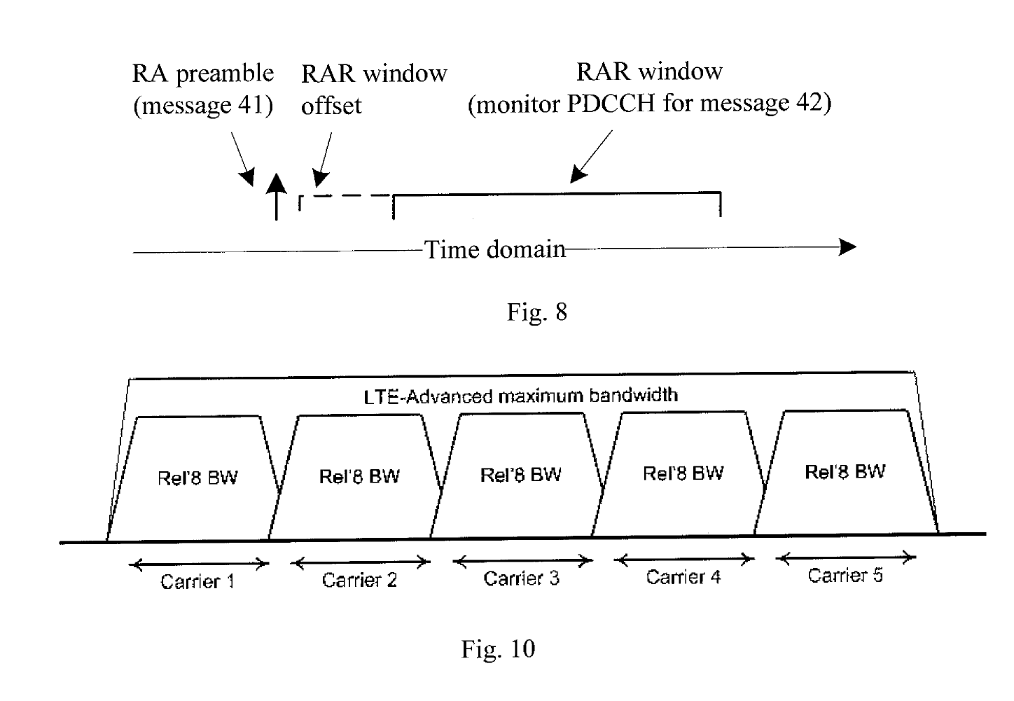

FIG. 8 shows an example for the timing of random access preamble and random access response windows;

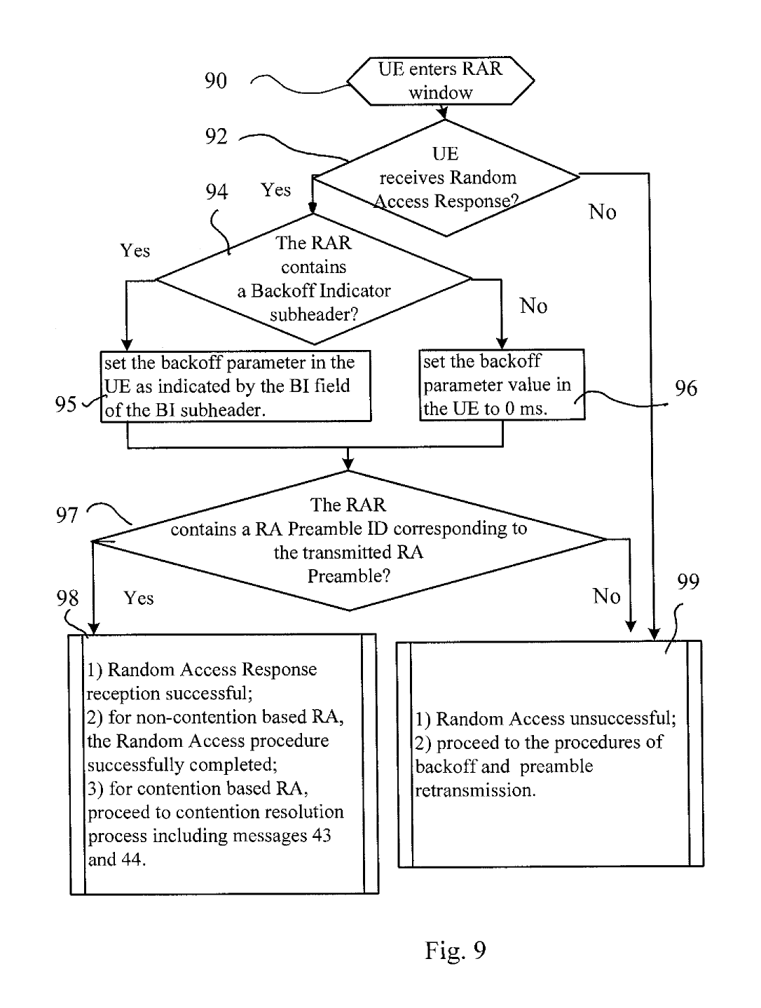

FIG. 9 shows an example for operation of a communication device in a random access response window without carrier aggregation;

FIG. 10 shows an example of carrier aggregation;

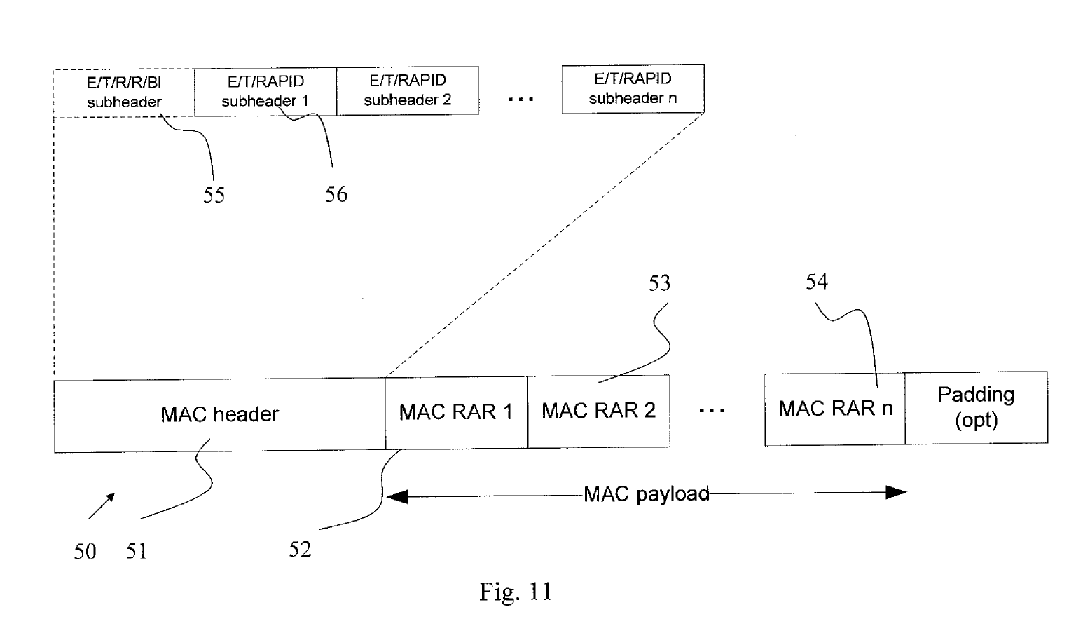

FIG. 11 shows an example of a protocol data unit consisting of a header and random access responses;

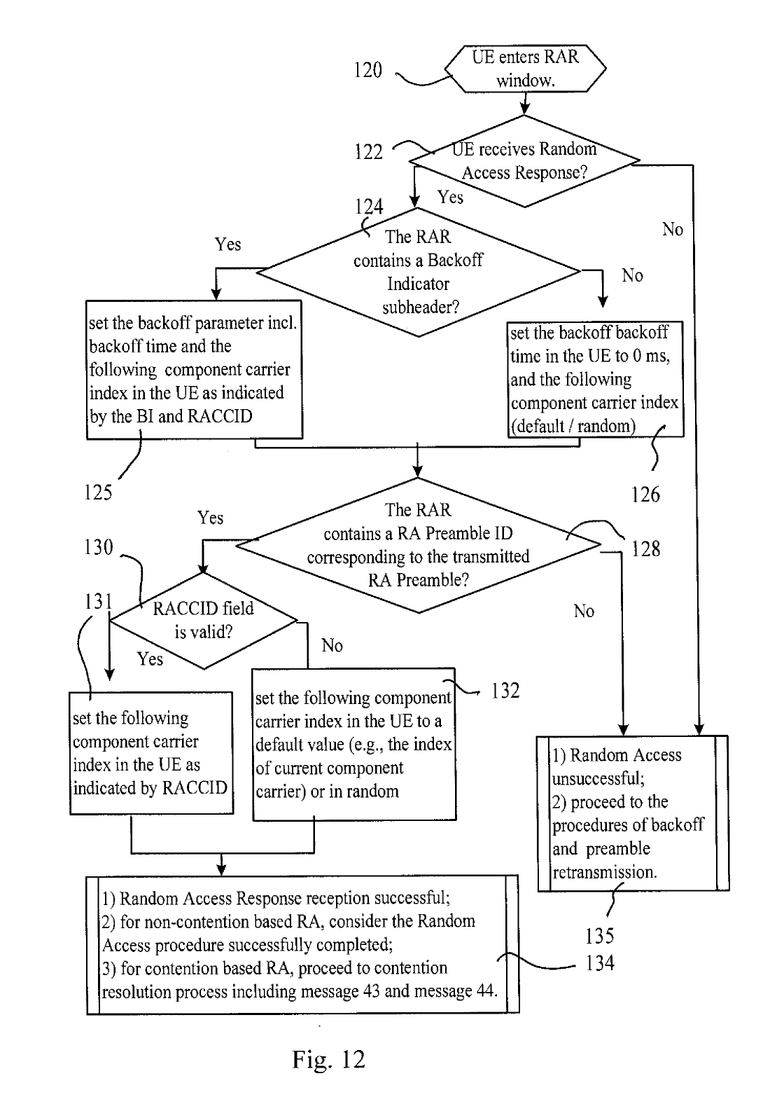

FIG. 12 shows an example for operation of a communication device in a random access response window with carrier aggregation; and

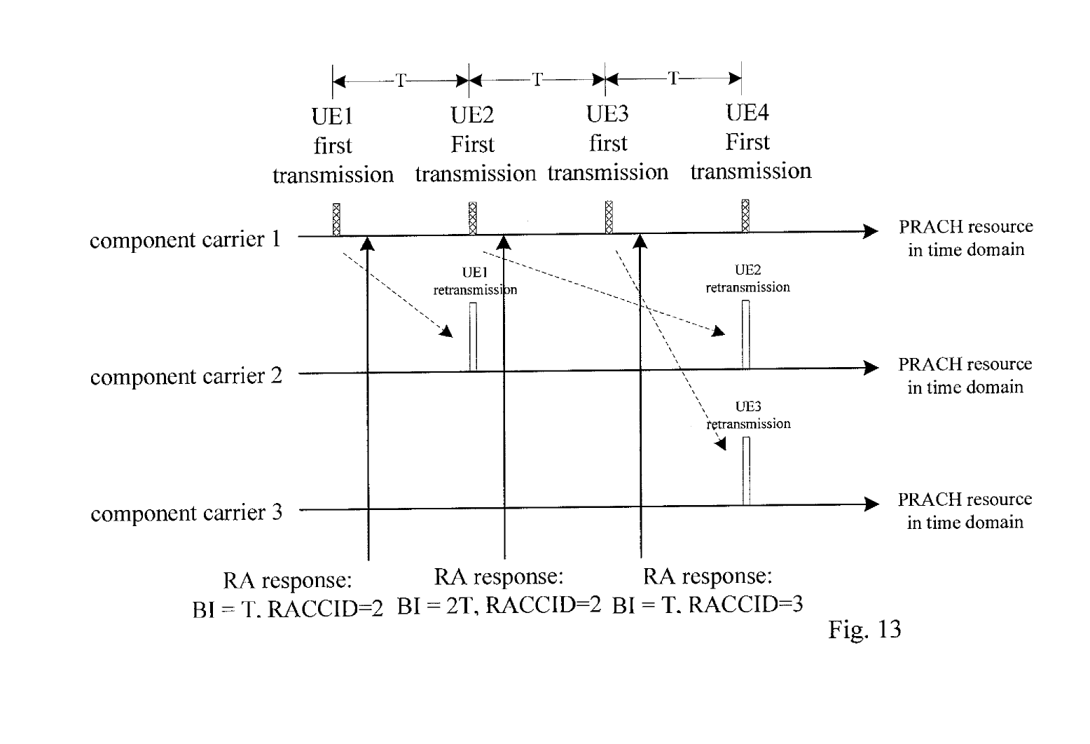

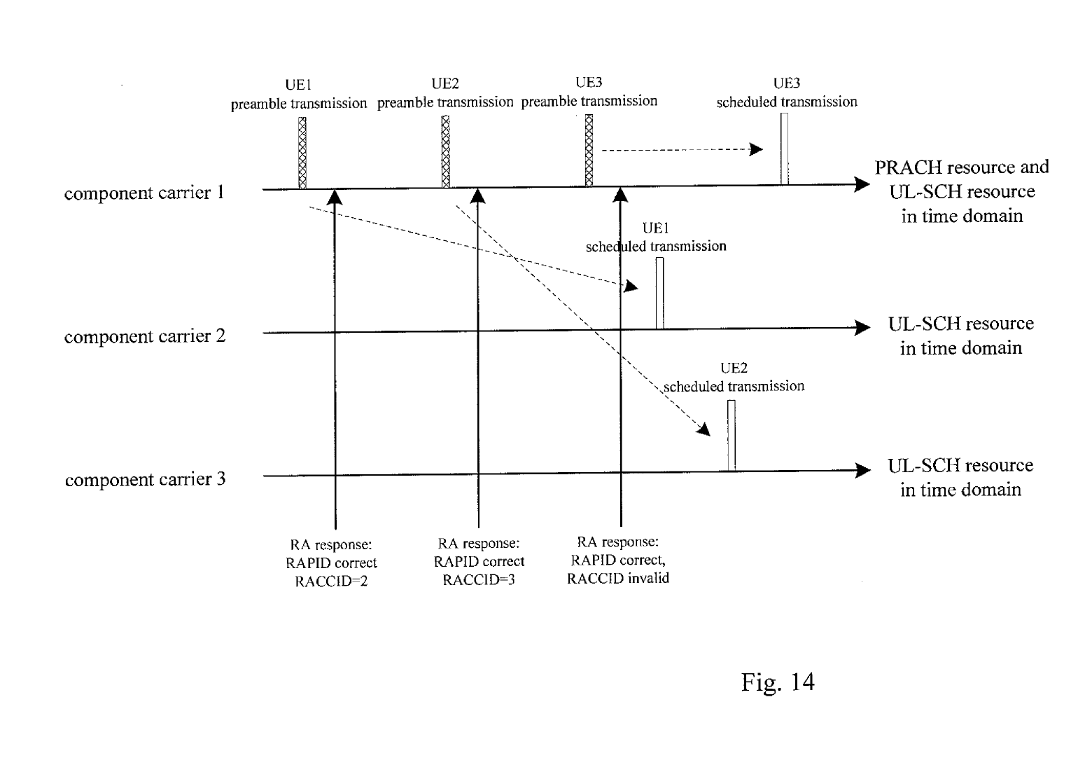

FIGS. 13 and 14 show two examples for the use of a component carrier indication.

In the following certain exemplifying embodiments are explained with reference to wireless or mobile communication systems serving mobile communication devices. Before explaining in detail the certain exemplifying embodiments, certain general principles of a wireless communication system and mobile communication devices are briefly explained with reference to FIGS. 1 and 2 to assist in understanding the technology underlying the described examples.

A communication device can be used for accessing various services and/or applications provided via a communication system. In wireless or mobile communication systems the access is provided via an access interface between mobile communication devices 1 and an appropriate wireless access system 10. A mobile device 1 can typically access wirelessly a communication system via at least one base station 12 or similar wireless transmitter and/or receiver node of the access system. A base station site typically provides one or more cells of a cellular system. In the FIG. 1 example the base station 12 is configured to provide a cell, but could provide, for example, three sectors, each sector providing a cell. Each mobile device 1 and base station may have one or more radio channels open at the same time and may receive signals from more than one source.

A base station is typically controlled by at least one appropriate controller so as to enable operation thereof and management of mobile communication devices in communication with the base station. The control entity can be interconnected with other control entities. In FIG. 1 the controller is shown to be provided by block 13. The controller is typically provided with memory capacity and at least one data processor 14. It shall be understood that the control functions may be distributed between a plurality of controller units.

In the FIG. 1 example the base station node 12 is connected to a data network 20 via an appropriate gateway 15. A gateway function between the access system and another network such as a packet data network may be provided by means of any appropriate gateway node, for example a packet data gateway and/or an access gateway. A communication system may thus be provided by one or more interconnect networks and the elements thereof, and one or more gateway nodes may be provided for interconnecting various networks.

A communication device can be used for accessing various services and/or applications. The communication devices can access the communication system based on various access techniques, such as code division multiple access (CDMA), or wideband CDMA (WCDMA). The latter technique is used by communication systems based on the third Generation Partnership Project (3GPP) specifications. Other examples include time division multiple access (TDMA), frequency division multiple access (FDMA), space division multiple access (SDMA) and so on. A non-limiting example of mobile architectures where the herein described principles may be applied is known as the Evolved Universal Terrestrial Radio Access Network (E-UTRAN). Non-limiting examples of appropriate access nodes are a base station of a cellular system, for example what is known as NodeB or enhanced NodeB (eNB) in the vocabulary of the 3GPP specifications. The eNBs may provide E-UTRAN features such as user plane Radio Link Control/Medium Access Control/Physical layer protocol (RLC/MAC/PHY) and control plane Radio Resource Control (RRC) protocol terminations towards mobile communication devices. Other examples include base stations of systems that are based on technologies such as wireless local area network (WLAN) and/or WiMax (Worldwide Interoperability for Microwave Access).

FIG. 2 shows a schematic, partially sectioned view of a communication device 1 that can be used for communication on a carrier 11 comprising a plurality of component carriers, for example with at least one base station. An appropriate mobile communication device may be provided by any device capable of sending and receiving radio signals. Non-limiting examples include a mobile station (MS), a portable computer provided with a wireless interface card or other wireless interface facility, personal data assistant (PDA) provided with wireless communication capabilities, or any combinations of these or the like.

A mobile communication device may be used for voice and video calls, for accessing service applications provided via a data network. The mobile device 1 may receive signals via appropriate apparatus for receiving and transmitting radio signals. In FIG. 2 a transceiver is designated schematically by block 7. The transceiver may be provided for example by means of a radio part and associated antenna arrangement. The antenna arrangement may be arranged internally or externally to the mobile device. A mobile device is also typically provided with at least one data processing entity 3, at least one memory 4 and other possible components 9 for use in tasks it is designed to perform. The data processing, storage and other entities can be provided on an appropriate circuit board and/or in chipsets. This feature is denoted by reference 6. The user may control the operation of the mobile device by means of a suitable user interface such as key pad 2, voice commands, touch sensitive screen or pad, combinations thereof or the like. A display 5, a speaker and a microphone are also typically provided. Furthermore, a mobile device may comprise appropriate connectors (either wired or wireless) to other devices and/or for connecting external accessories, for example hands-free equipment, thereto.

FIG. 3 shows an example of a controller apparatus 30 comprising at least one memory 31, at least one data processing unit 32, 33 and an input/output interface 34. The controller 30 may be configured to execute an appropriate software code to provide the control functions as explained below in more detail. The controller 30 can be provided for controlling one single composite carrier or a number of composite carriers provided by a base station in accordance of the principles of the below explained embodiments.

An embodiment for controlling transmissions on a composite carrier comprising at least two carriers is shown in the flowchart of FIG. 4. A controller, for example the controller 30 of FIG. 3, of a provider of the composite carrier receives a message at 100 from a device attempting to access the composite carrier. The message can be, for example, a request for random access. The provider can be, for example, a base station or another communication device.

The controller 30 of the provider is configured to control the composite carrier or carriers that shall be used by the device for subsequent transmissions. Thus at 102 the controller includes in a response an indication of at least one component carrier of a composite carrier to be used by the device for at least a subsequent transmission on the composite carrier. The selected component carrier may be the same as used at 100, or the controller may determine that at least different component carrier than what was used for the sending of the message at 100 shall be used. The response with this information of the at least one component carrier is then sent to the device at 104. The device may then transmit accordingly on the composite carrier, and the transmission is received by the provider of the composite carrier at 106.

Another embodiment for controlling transmissions on a composite carrier comprising at least two carriers is shown in the flowchart of FIG. 5. A controller, for example controller 3 of the mobile communication device of FIG. 2, receives a message at 202 from a provider of a composite carrier the device is attempting to access. The message can be, for example, a response to a request for random access sent by the device to the provider at 200. The controller may then determine at 204, based on the message it received, at least one component carrier that is to be used by the device for at least one subsequent transmission on the composite carrier. After the determination of the component carrier the device can transmit on the determined at least one component carrier at step 206.

The determining may comprise, for example determining if the response includes an indication of at least one component carrier that shall be used by the device for at least one subsequent transmission on the composite carrier. The controller may also determine if the response contains a backoff indicator subheader or the like, and then decide which component carrier to use accordingly. A backoff indicator, or alike indicator, is typically used for indicating the configuration when the preamble retransmission after a certain time delay is to be executed followed by a random access failure.

In accordance with a possibility the controller can determine if the response contains information regarding at least one component carrier to be used by the device for at least one subsequent transmission on the composite carrier. If it is determined that such information cannot be found, the controller can decide to use a default component carrier, for example select a carrier based on index that is derived based on the index of the component carrier used at step 200 and/or at step 202, or select a component carrier in random. The component carrier index can be derived e.g. by increasing or decreasing the value of the index of the component carrier used at 200 by a predefined integer. Another appropriate function may also be used to achieve a desired distribution of component carrier assignments.

More detailed examples of operation in accordance with certain embodiments will now be explained below with reference to transmissions in access systems such as those based on the 3GPP Long Term Evolution (LTE). In the LTE releases up to release 8 only one carrier may be provided for use for communications between a base station, for example an enhanced Node B (eNB), and a communication device. In accordance with the 3GPP specifications the random access procedure can take two distinct forms, i.e. contention based and non-contention based access. Contention based access is typically applicable to all random access events. Non-contention based access that is typically applicable to only handover and downlink (DL) data arrival when uplink (UL) synchronisation status is non-synchronised. A contention based random access (RA) process typically includes four steps, as shown for example in FIG. 6. FIG. 7, in turn shows the three typical steps for non-contention based random access. Each of the steps corresponds to a message either from the communication device (UE) to the base station (eNB), or from the base station (eNB) to the user device (UE).

An illustration of the timing of random access preamble and random access response window is shown in FIG. 8. The preamble message 41 of FIGS. 6 and 7 from the communication device UE to the eNB is typically called random access (RA) preamble. The following message from the eNB to the user communication device (UE) is called random access response, this being denoted as message 42 in FIGS. 6, 7 and 8. Once the random access preamble, i.e. message 41, is transmitted, the communication device UE shall monitor Physical Downlink Control Channel (PDCCH) in the following Transmission Time Interval (TTI) window for random access response (RAR), i.e. for message 42. A concept of random access response window (RAR window) is defined as a subframe window when the communication device UE monitors the PDCCH for a possible random access response after transmission of a random access preamble. The communication device UE would stop monitoring after successful reception of a random access response corresponding to the random access preamble transmission or when random access response window expires. For example, in the current 3GPP specifications, the length of the window can be set from 2 ms to 10 ms, and the offset can be 2 ms.

If the reception of the random access response is successful, a first Scheduled Transmission, or message 43, is sent from the device UE to the station eNB according to uplink grant contained in the random access response. A message called Contention Resolution, shown as message 44 in FIG. 6, can also be sent from the eNB to the UE if the eNB accepts the random access requirement of this UE.

A typical behaviour of a communication device (UE) during random access response window according to the current 3GPP LTE specifications is illustrated in the flowchart of FIG. 9. As shown, after a communication device enters a random access window at 90, it can receive a response at 92. The response can include a backoff indicator subheader. Presence of this is determined at 95, and the process continues such that the backoff parameter is set in the communication device either in accordance with the response at 95 or to 0 at 96. It is also determined at 97 if the random access response (RAR) contains a random access (RA) preamble identifier corresponding to the transmitted random access preamble. If yes, the random access process is considered successful at 98. If no, the random access attempt is considered unsuccessful at 99.

Current proposals for carrier aggregation in LTE-A systems will now be explained briefly. In carrier aggregation two or more carriers, referred to as component carriers are aggregated such that a communication device may simultaneously receive one or multiple component carriers depending on its capabilities. For example, an LTE-Advanced mobile communication device with reception capability beyond 20 MHz can simultaneously receive on multiple component carriers. The carrier aggregation is at present considered for LTE-Advanced to support downlink transmission bandwidths larger than 20 MHz, but the use thereof is naturally not restricted by this. A requirement that has been proposed for LTE-A is that it should operate in spectrum allocations of different sizes including wider spectrum allocations than those of the current Release 8 LTE, e.g. up to 100 MHz, to achieve the peak data rate of 100 Mbit/s for high mobility and 1 Gbit/s for low mobility.

FIG. 10 gives an example of the carrier aggregation. In the example a plurality Rel8 bandwidth “chunks”, or component carriers, are combined together to form M×Rel8 bandwidth (BW). For example, given M=5, one would have 5×20 MHz=100 MHz. As mentioned above, Release 8 compatible communication devices can receive/transmit only on one component carrier. However, LTE-Advanced communication may also receive/transmit on multiple component carriers simultaneously, and thus reach higher bandwidths.

If carrier aggregation is employed the control channel(s) can be designed in various manners. For example, in LTE-A a Physical Downlink Control Channel (PDCCH) can be provided as a separate PDCCH per assigned component carrier. Alternatively, only one global PDCCH can be provided for signalling the allocations for all component carriers jointly. In the latter alternative, a component carrier containing the PDCCH can be called “primary component carrier” and the other component carriers without the PDCCH can be called “secondary component carriers.

In accordance with a proposal a physical random access channel (PRACH) resource can be provided in each component carrier of an aggregated carrier. This can be so to provide more chance for a communication device to access and larger frequency diversity, and hence to reduce collision probability.

The design of random access procedure in the medium access control (MAC) layer in LTE-A may become problematic since the entire process from preamble transmission (i.e. message 41 of FIG. 6) to contention resolution (message 44 of FIG. 6) may need to be executed within a single component carrier, thus increasing the possibility that a large number of communication devices perform random access in one carrier. If these communication devices are restricted into the original component carrier constantly regardless of preamble retransmission and contention resolution, they may experience larger preamble collision probability, longer access delay, and heavier load in uplink channel resource. On the other hand, multiple component carriers can be advantageously used to improve performance of a random access procedure.

In the following more detailed example a physical random access channel (PRACH) is configured in each component carrier in an advanced long term evolution (LTE-A) system. The random access response, i.e. message 42 of FIG. 6, can be modified to carry information about the component carriers.

In accordance with an embodiment a new field or information element can be added into the random access response message 42 in FIGS. 6 and 7, see information element “Component Carrier ID”. The information can be used to indicate a component carrier where the following procedures are to be executed. For example, this information can then be used to indicate the index of component carrier where the following procedures are to be executed In some of the detailed examples this new information is termed Random Access Component Carrier IDentifier (RACCID).

Addition of a component carrier ID field into the random access response message 42 can be activated periodically in the time domain, dynamically according to the load situation, or in response to another predefined event. For example, the inclusion of the indicator may be triggered by detected interference and/or error affecting some but not all of the component carriers. By means of this it is possible to avoid insertion of the indication in every random access response message 42.

The method can also involve associated procedures, for example procedures such as preamble retransmission in message 41 of FIGS. 6 and 7 and scheduled transmissions, typically the first scheduled transmission, i.e. message 43 in FIG. 6.

The design of this embodiment can be advantageous in various ways. For example, considering a random access procedure such as the one described in the LTE-A specification, a component carrier indication for preamble retransmissions or the first scheduled transmissions by Random Access Component Carrier IDentifier (RACCID) field can help alleviate heavy load in one component carrier's physical random access channel (PRACH) or uplink shared channel (UL-SCH) resource. A good balance may be achieved over all of the component carriers. This can assist in the attempts to decrease access delay, reduce preamble collision probability, and improve preamble detection and contention resolution performance.

Examples of inserting a Random Access Component Carrier IDentifier (RACCID) field in a Random access response will now be explained with reference to FIGS. 11 and 12. The flowchart of FIG. 12 shows a possible behaviour of a user communication device during a random access response (RAR) window the device has entered at 120 in accordance with an embodiment. In the FIG. 12 flowchart the steps of checking and updating of a RACCID field are added to the access procedure when compared to the Flowchart of FIG. 9.

Currently a medium access control (MAC) protocol data unit (PDU) 50 for Random Access Response (RAR) can consist of a MAC header 51 and one or more MAC Random Access Responses (RAR) 52, 53 and 54. A MAC PDU header can consist of one or more MAC PDU sub-headers 55. Each subheader can correspond to a MAC RAR except for a Backoff Indicator sub-header. A MAC PDU subheader other than a Backoff Indicator subheader is called “normal subheader” below. A normal subheader can contain a Random Access Preamble IDentifier (RAPID) field. Instead of this, a Backoff Indicator subheader can contain a Backoff Indicator (BI) field.

A Random Access Component Carrier IDentifier (RACCID) field can be added into a random access response message carried on a MAC PDU and received by a communication device in a random access window at step 122 of FIG. 12. For example, the field can be added into the subheaders 55, i.e. a backoff indicator subheader, and 56, i.e. normal subheaders, of the MAC PDU 50. The insertion of this information in the response may be provided by various manners. For example, one or more RACCID fields can be added into a Backoff Indicator subheader 55 which is used for the configuration of preamble retransmission on PRACH in message 41.

If multiple RACCID fields are contained in a Backoff Indicator subheader 55, the communication device receiving the message can select one of them randomly. The probability of the component carrier selection may be made even amongst the component carriers, or be weighted in favours of certain component carriers.

In accordance with another approach only one RACCID field can be added into the normal subheader 56 which is used for the configuration of the first scheduled uplink (UL) transmission by message 43.

In accordance with another embodiment, if a random access response MAC PDU containing a Backoff Indicator subheader is received during a random access response (RAR) window, see 124 of FIG. 12, the communication device can set the index of component carrier at 125 where the preamble retransmission is to be executed as indicated in RACCID. If no Backoff Indicator subheader is received at 124, a default value, for example the index of current component carrier can be used at step 126. In accordance with a possibility, the index can be derived e.g. by adding or subtracting a predefined value to/from the index of current component carrier. In accordance with a possibility a randomly selected index value can be used.

In accordance with an embodiment, a random access response MAC PDU that contains a normal subheader corresponding to its transmitted preamble is detected at 128 as being received during a random access response window, and contention based random access (RA) procedure is configured. If it is determined at 130 that the indicator field is valid, the communication device can set the index of component carrier at 131 where a first or another scheduled uplink transmission is to be executed as indicated by the received indicator.

Otherwise, either a default value, e.g. the index of current component carrier, or an index derived based on the current index, or a randomly selected value can be set and used at 132 instead.

If the access is non-contention based random access, and preamble retransmission is needed, a dedicated preamble may need to be kept valid on the component carrier that is indicated by a RACCID field. That is, the preamble should still be dedicated to the original communication device on the indicated component carrier.

Additionally, the premise of component carrier change for message 43 can be to allow inter-carrier scheduling. That is, an uplink grant contained in a random access response message 42 can also indicate the resource allocation in another component carrier. Thus an uplink grant can be transmitted in one component carrier and the resource allocation message used for the subsequent message 43 can be transmitted in another component carrier.

The further development of LTE-A should be backwards compatible with Release 8 LTE in the sense that a Release 8 LTE terminal can work also in LTE-A system and that a LTE-A terminal can work in a Release 8 LTE system. For this reason, the design of non-transparent transmission control concept with backward-compatibility with the existing LTE compatible devices, for example with devices known as LTE release 8 compatible user equipment (R8 UE) would be desired. The backwards compatibility can be provided by ignoring the component carrier indication and/or any detection and/or selection rules associated therewith. For example, if a LTE Release 8 communication device that has accessed a LTE-A network receives a random access response, it may ignore the component carrier indicator field and execute the following procedures in the current component carrier. On the other hand, if a LTE-A communication device working in LTE network receives a random access response, it can apply the current carrier to the following procedures. Thus an LTE Rel-8 capable communication device can receive transmissions on a single component carrier only, provided that the structure of the component carrier follows the Release 8 specifications.

The introduction of a component carrier indication, for example the above mentioned RACCID field, in a random access response can be used in load balancing. It can be advantageously used for example for a physical random access channel (PRACH) resource where random access preamble such as message 41 of FIG. 6 is transmitted. Also, advantage may be obtained if used in association with an uplink shared channel (UL-SCH) resource where the first scheduled transmission, e.g. message 43 of FIG. 6, is transmitted.

In accordance with a possible use scenario a component carrier indication is used in association with preamble retransmissions. A base station may detect a heavy load in a component carrier in a physical random access channel (PRACH) including a first transmission and one or more sequent retransmissions of a preamble. This can result in preamble collision or detection difficulty. If the preamble retransmissions are continued in this component carrier, it is likely that the transmission does not succeed due to congested RACH. Furthermore, such retransmission may impact the new random access procedures initiated by other communication devices over this component carrier, which results in longer access delay and larger backoff time for both existing and new ones. This problem may also be removed or at least mitigated by means of a component carrier indication, for example by indicating the indexes of one or multiple component carriers by a component carrier indication field in a backoff Indicator subheader of a MAC PDU. Then, the retransmissions can be moved away from the original component carrier to one(s) where random access load is on acceptable levels in the access channel. In this way, the load of the access channel in the original component carrier can be alleviated as well.

FIG. 13 shows an exemplary illustration of how the retransmissions can be moved to other component carriers of an aggregated carrier. In this example the preamble retransmissions are moved from component carrier 1 to component carrier 2 and 3. For example, the first transmission of UE1 can take place in the component carrier 1 whereas the retransmission can take place in component carrier 2. UE2 is treated similarly, apart from the timing of the retransmission which is different. The first transmission of UE3 can also take place in the component carrier 1 whereas the retransmission may take place in component carrier 3.

In accordance with another exemplifying use scenario a component carrier indication is used for a first scheduled transmission. A base station may detect a heavy load in an uplink shared channel (UL-SCH) in a component carrier including first scheduled transmissions in random access and other uplink transmissions. The heavy load may be a result of the resource of UL-SCH being shared by a plurality or all communication devices in the cell. If the following contention resolution procedures are continued in this component carrier this may result in scheduling difficulties due to resource scarcity. To resolve this issue, the index of one or more component carriers where traffic load is not so heavy in the uplink shared channel (UL-SCH) can be indicated by the component carrier indicator field in each individual normal subheader of a medium access control protocol data unit (MAC PDU). Different subheaders can indicate different component carriers. This can be used to alleviate the scheduling burden in the original component carrier.

FIG. 14 shows an exemplary illustration of this. In FIG. 14 the first scheduled transmissions are moved from component carrier 1 to component carrier 2 and 3, or remained in the original component carrier. More particularly, the first scheduled transmissions of UE1 is moved from component carrier 1 to component carrier 2, the first scheduled transmissions of UE3 is moved from component carrier 1 to component carrier 3, whilst the first scheduled transmissions of UE3 is transmitted on component carrier 1. Thus the load in this example is substantially equally balanced between the three component carriers.

The proposed design may benefit in scenarios where balanced load of random access is required throughout multiple component carriers. The embodiment can be applied for different multiplexing schemes, e.g. for frequency division duplexing (FDD) and time division duplexing (TDD). Time-Division Duplex (TDD) is an application of time-division multiplexing where outward and return signals are separated based on time. It emulates full duplex communication over a half duplex communication link. In Frequency-division duplex (FDD) the transmitter and receiver operate at different carrier frequencies, and the uplink and downlink sub-bands are separated by the “frequency offset”. Both of these techniques may be used by a transceiver.

The required data processing apparatus and functions of a base station apparatus as well as an appropriate communication device may be provided by means of one or more data processors. The described functions may be provided by separate processors or by an integrated processor. The data processing may be distributed across several data processing modules. A data processor may be provided by means of, for example, at least one chip. Appropriate memory capacity can also be provided in the relevant nodes. An appropriately adapted computer program code product or products may be used for implementing the embodiments, when loaded on an appropriate data processing apparatus, for example for including appropriate carrier indications in a processor apparatus 13 associated with the base station 12 shown in FIG. 1 and/or for the described detecting and selection operations in a data processing apparatus 3, 4 and 9 of the mobile communication device 1 of FIG. 2. The program code product for providing the operation may be stored on, provided and embodied by means of an appropriate carrier medium. An appropriate computer program can be embodied on a computer readable record medium. A possibility is to download the program code product via a data network.

It is noted that whilst embodiments have been described in relation to LTE-Advanced, similar principles can be applied to any other communication system where a composite carrier comprising a multiple of component carriers is employed. Also, instead of carriers provided by a base station a composite carrier comprising component carriers may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the scope of the present invention.

1. A method for controlling transmissions on a composite carrier comprising at least two component carriers, comprising receiving a message from a device attempting to transmit on the composite carrier; including in a response an indication of at least one component carrier to be used by the device for a subsequent transmission; and
sending the response to the device.

2. A method as claimed in claim 1, comprising including the indication in a random access response.

3. A method as claimed in claim 1, comprising including the index of at least one component carrier in the response.

4. A method as claimed in claim 1, comprising including an indication of a component carrier for a subsequent preamble retransmission or a scheduled transmission.

5. A method as claimed in claim 1, comprising distributing loading on component carriers by sending different indications in response to different received messages and/or messages from different devices.

6. A method as claimed in claim 1, comprising including the indication periodically in the time domain or dynamically in response to load and/or in response to a predefined event.

7. A method as claimed in claim 1, wherein the composite carrier and the component carriers provide carrier aggregation in accordance with the specifications by the third generation partnership project.

8. A method as claimed in claim 1, comprising adding a field for carrying the indicator into at least one subheader of a medium access control protocol data unit.

9. A method for transmitting by a device on a composite carrier comprising at least two component carriers, comprising receiving a message from a provider of the composite carrier; determining based on the message at least one component carrier to be used by the device for at least one subsequent transmission; and transmitting on the determined at least one component carrier.

10. A method as claimed in claim 9, comprising sending a message to the provider on the composite carrier, receiving a response from the provider within a predefined period, and determining based on the response the at least one component carrier to be used for the at least one subsequent transmission.

11. A method as claimed in claim 9, wherein the determining comprises determining if the received message includes an indication of at least one component carrier to be used by the device for at least one subsequent transmission on the composite carrier.

12. A method as claimed in claim 9, wherein the determining comprises determining if the received message contains a backoff indicator.

13. A method as claimed in claim 9, wherein the determining comprises determining if the received message contains information regarding at least one component carrier to be used by the device for at least one subsequent transmission on the composite carrier, and in the absence of such information, determining a default component carrier or selecting a component carrier in random.

14. A method as claimed in claim 9, wherein the message received from the station comprises a random access response.

15. A method as claimed in claim 14, comprising monitoring Physical Downlink Control Channel (PDCCH) for a random access response (RAR) to detect a field in a subheader of a medium access control protocol data unit capable of carrying information of component carrier assignments.

16. A method as claimed in claim 9, wherein the received message is configured to carry an index of at least one component carrier.

17. A method as claimed in claim 9, wherein the transmitting comprises transmitting a preamble retransmission or a scheduled transmission.

18. A method as claimed in claim 9, comprising detecting that multiple component carriers are indicated by the received message and selecting one or multiple of the indicated component carriers in random.

19. A method as claimed in claim 9, comprising weighting at least one of the component carriers in the selection.

20. A method as claimed in claim 9, comprising selecting one of the component carriers indicated by the received message based on a predefined selection rule.

21. A method as claimed in claim 9, wherein the composite carrier and the component carriers provide carrier aggregation in accordance with the specifications by the third generation partnership project.

22. A control apparatus for a communication system capable of providing a composite carrier comprising at least two component carriers, the control apparatus being configured to control transmissions on the composite carrier based on information regarding an attempt by at least one device to transmit on the composite carrier, to include in a message to the at least one device an indication of at least one component carrier to be used by the at least one device for at least one subsequent transmission, and to send the message to the at least one device.

23. A control apparatus for a communication device adapted for communications on a composite carrier comprising at least two component carriers, the control apparatus being configured to control transmissions based on a message received from a provider of the composite carrier, wherein the control apparatus is configured to determine based on the message at least one component carrier to be used by the communication device for at least one subsequent transmission and to instruct transmission on the determined at least one component carrier.

24. A control apparatus as claimed in claim 23, wherein the controller apparatus is configured to determine if the received message includes an indication of at least one component carrier to be used by the device for at least one subsequent transmission.

25. A control apparatus as claimed in claim 22, wherein the indication is included in a random access response.

26. A control apparatus as claimed in claim 22, wherein the indication comprises the index of at least one component carrier.

27. A control apparatus as claimed in claim 22, wherein the message includes an indication of a component carrier to be used for a subsequent preamble retransmission or a scheduled transmission.

28. A control apparatus as claimed in claim 22, wherein the message comprises a response to a message received from a device, the controller apparatus being configured to provide load balancing by including different indications in responses to different received messages and/or messages from different devices.

29. A control apparatus as claimed in claim 22, wherein a component carrier indication is included in the message periodically in the time domain or dynamically in response to load and/or a predefined event.

30. A control apparatus as claimed in claim 22, wherein the message comprises a medium access control protocol data unit containing an indicator of a component carrier in at least one subheader thereof.

31. A control apparatus as claimed in claim 23, wherein the controller apparatus is configured to send a message to the provider on the composite carrier, to detect a response received from the provider within a predefined period, and to determine based on the response at least one component carrier to be used.

32. A control apparatus as claimed in claim 22, wherein the message contains a backoff indicator.

33. A control apparatus as claimed in claim 23, wherein the controller apparatus is configured to determine if a received message contains information regarding at least one component carrier to be used by the device for at least one subsequent transmission on the composite carrier, and in the absence of such information, to determine a default component carrier or select a component carrier in random.

34. A control apparatus as claimed in claim 23, wherein the controller apparatus is configured to detect if multiple component carriers are indicated by the received message and to select one or multiple of the component carriers in random.

35. A control apparatus as claimed in claim 22, wherein the composite carrier comprises an aggregated carrier in accordance with the specifications by the third generation partnership project.

36. A message for controlling communications on a composite carrier comprising at least two component carriers, the message comprising a medium access control protocol data unit configured to carry in at least one subheader thereof an indicator of a component carrier to be used by a communication device for at least one subsequent transmission.

37. A computer program comprising program code means adapted to perform the steps of claim 1 when the program is run on a data processing apparatus.

38. A communication system comprising a controller apparatus in accordance with claim 22.
